(19) United States
(12) Patent Application Publication
(10) Pub. No.: US 2021/0131460 A1
(43) Pub. Date: May 6, 2021

(54) Hierarchical Conforming Gripping Arrays

(71) Applicant: California Institute of Technology, Pasadena, CA (US)

(72) Inventors: Punnathat Bordeenithikasem, Pasadena, CA (US); Victor E. White, Altadena, CA (US); Kalind C. Carpenter, Pasadena, CA (US); Douglas C. Hofmann, Altadena, CA (US)

(73) Assignee: California Institute of Technology, Pasadena, CA (US)

(21) Appl. No.: 17/089,629

(22) Filed: Nov. 4, 2020

Related U.S. Application Data
(60) Provisional application No. 62/930,463, filed on Nov. 4, 2019.

(51) Int. Cl. F16B 2/00; C22C 45/10; C22C 45/00; B22D 21/00

(52) U.S. Cl. CPC F16B 2/005; C22C 45/10; B22D 21/00; C22C 45/005; C22C 45/003

(57) ABSTRACT

Bulk metallic glass-based gripping arrays of nano- or micro-scale grippers are described, along with the methods of fabrication and use thereof. BMG-based gripping arrays can be fabricated via facile and scalable thermoplastic forming/molding methods typically available to polymeric materials, yet they possess many of the favorable properties of metallic alloys that polymers lack, such as, for example, excellent mechanical properties and robustness towards wear and adverse surrounding conditions.

### CROSS-REFERENCE TO RELATED APPLICATIONS

The present application claims priority under 35 U.S.C. 119(e) to U.S. Provisional Application No. 62/930,463, entitled “Hierarchical Conforming Gripping Arrays” to Bordeenithikasem et al., filed Nov. 4, 2019, the disclosure of which is incorporated herein by reference in its entirety.

### STATEMENT REGARDING FEDERALLY SPONSORED RESEARCH

This invention was made with Government support under Grant No. 80NM0018D004 awarded by NASA (JPL). The Government has certain rights in this invention.

### FIELD OF THE INVENTION

The invention is generally directed to gripping arrays comprising bulk metallic glass, methods of nano- and micro-fabrication thereof via thermoplastic forming, and use thereof.

### BACKGROUND OF THE INVENTION

Gripping systems that mechanically adhere to a surface upon contact and help propel a mobility/robotic platform, for example, up along a vertical wall, or another terrain, can have a variety of uses, however, the need for such grippers is particularly dire in space exploration applications. Many current approaches to gripping systems and mechanisms rely on various microspines or gecko feet-inspired adhesives, which, in turn, rely on arrays of very thin synthetic setae (hair-like bristles). Typically, such systems are made from flexible polymeric materials, which are amenable to facile and easily scalable molding and forming methods that can produce the desired structures at the nano- or micro-scales. However, the polymeric materials used for practical manufacturing of such gripping nano- or micro-scale structures have poor mechanical properties and are not compatible with operation in extreme conditions, such as, for example, outer space, where the adverse conditions include vacuum, radiation, and extreme temperatures. In contrast, metallic materials are more desirable for space exploration applications (as well as wear resistance in general), but they present a number of manufacturing challenges with regard to the fabrication of features at nano- and micro-scale. Accordingly, new solutions to implementing feasible, metal-based gripping systems in a variety of mobility platforms and settings are highly desired.

### SUMMARY OF THE INVENTION

Various embodiments are directed to a gripping array including:
a substrate, characterized by a substrate thickness and a substrate area; and
a plurality of grippers covering the substrate, each gripper comprising a stalk, characterized by a stalk length and a stalk width, and an anchoring tip at the available end of the stalk, characterized by an anchoring tip geometry and at least one anchoring tip dimension, wherein
the plurality of grippers comprises a bulk metallic glass, and wherein
the gripping array is characterized by a gripper density, a gripper pattern, and an ability to adhere to a surface having surface features upon a contact between the surface and the plurality of grippers.

In various such embodiments, the bulk metallic glass is selected from the group consisting of: Zr₃₅Ti₃₀Cu_{8.25}Be_{26.75}, Zr₄₄Ti₁₁Cu₁₀Ni₁₀Be₂₅, Zr_{41.2}Ti_{13.8}Ni_{12.5}Cu₁₀Be_{22.5}, Pd₄₃Cu₂₇Ni₁₀P₂₀, Pt_{57.5}Cu_{14.7}Ni_{5.3}P_{22.5}, Au₄₉Ag_{5.5}Pd_{2.3}Cu_{26.9}Si_{16.3}, Mg₆₅Cu₂₅Y₁₀.

In still various such embodiments, the plurality of grippers is characterized by microscale dimensions.

In yet various such embodiments, the plurality of grippers is characterized by nanoscale dimensions

In yet still various such embodiments, the stalk length is microscale and the at least one anchoring tip dimension is nanoscale.

In still various such embodiments, the stalk length is at least 10 times larger than the at least one anchoring tip dimension.

In still yet various such embodiments, the stalk length is at least 10 times larger than the stalk width.

In yet still various such embodiments, the stalk width is 1 micron to 1 millimeter.

In yet various such embodiments, the stalk width is 50 nm.

In yet still various such embodiments, the stalk length is 1 micron to 1 centimeter.

In still various such embodiments, the stalk length is 500 nm.

In still yet various such embodiments, the anchoring tip geometry is selected from the group consisting of: V, chicken feet, such as three-pronged chicken feet, star, circle, spider, hoe, single spine, another complex multi-pronged shape, and any combination thereof.

In yet various such embodiments, wherein the gripper pattern is selected from the group consisting of: hexagonal packing, cubic packing, and any combination thereof.

In still yet various such embodiments, at least one feature selected from the list consisting of: the stalk length, the stalk width, the at least one anchoring tip dimension, the gripper density, and the gripper pattern, are scaled with the surface features to optimally grip the surface.

In yet still various such embodiments, the substrate thickness and the substrate area are optimized to conform to the surface.

In various other embodiments are directed to a method of fabricating a gripping array including:
providing a bulk metallic glass alloy;
providing a precision mold, wherein the precision mold is a negative of the gripping array;
using a heated press to push the bulk metallic glass alloy into the precision mold and cooling the precision mold to from the gripping array comprising a bulk metallic glass; and
partially or fully removing the precision mold to reveal the gripping array comprising:
a substrate, characterized by a substrate thickness and a substrate area; and
a plurality of grippers covering the substrate, each gripper comprising a stalk, characterized by a stalk length and a stalk width, and an anchoring tip at the available end of the stalk, characterized by an anchoring tip geometry and at least one anchoring tip dimension, wherein
the plurality of grippers comprises the bulk metallic glass, and wherein
the gripping array is characterized by a gripper density, a gripper pattern, and an ability to adhere to a surface having surface features upon a contact between the surface and the plurality of grippers.

In various such embodiments, the bulk metallic glass alloy is selected from the group consisting of: Zr₃₅Ti₃₀Cu_{8.25}Be_{26.75}, Zr₄₄Ti₁₁Cu₁₀Ni₁₀Be₂₅, Zr_{41.2}Ti_{13.8}Ni_{12.5}Cu₁₀Be_{22.5}, Pd₄₃Cu₂₇Ni₁₀P₂₀, Pt_{57.5}Cu_{14.7}Ni_{5.3}P_{22.5}, Au₄₉Ag_{5.5}Pd_{2.3}Cu_{26.9}Si_{16.3}, Mg₆₅Cu₂₅Y₁₀.

In still various such embodiments, the precision mold comprises microscale features.

In yet various such embodiments, wherein the precision mold comprises microscale features, the precision mold comprises microetched silicon.

In yet still various such embodiments, wherein the precision mold comprises microscale features, the precision mold is fabricated using photolithography and deep reactive ion etching on silicon on insulator wafers.

In still yet various such embodiments, the precision mold comprises nanoscale features.

In still various such embodiments, wherein the precision mold comprises nanoscale features, the precision mold comprises a nanoporous material selected from the group consisting of: anodized aluminum oxide, Si, black Si, ceramic.

Still various embodiments are directed to a mobility platform comprising at least one gripping array including:
a substrate, characterized by a substrate thickness and a substrate area; and
a plurality of grippers covering the substrate, each gripper comprising a stalk, characterized by a stalk length and a stalk width, and an anchoring tip at the available end of the stalk, characterized by an anchoring tip geometry and at least one anchoring tip dimension, wherein
the plurality of grippers comprises a bulk metallic glass, and wherein
the gripping array is characterized by a gripper density, a gripper pattern, and an ability to adhere to a surface having surface features upon a contact between the surface and the plurality of grippers.

Additional embodiments and features are set forth in part in the description that follows, and in part will become apparent to those skilled in the art upon examination of the specification or may be learned by the practice of the disclosed subject matter. A further understanding of the nature and advantages of the present disclosure may be realized by reference to the remaining portions of the specification and the drawings, which form a part of this disclosure.

### BRIEF DESCRIPTION OF THE DRAWINGS

These and other features and advantages of the present invention will be better understood by reference to the following detailed description when considered in conjunction with the accompanying data and figures, wherein:

FIG. 1 provides a representative phase diagram for a bulk metallic glass (BMG) alloy, according to prior art.

FIG. 2 schematically describes an example of a manufacturing procedure for the fabrication of a gripping array with nano- or micro-scale gripping features, in accordance with embodiments of the application.

FIGS. 3A through 3D show various microscopy views of a gripping array with microscale features fabricated with high fidelity from a BMG via thermoplastic forming (TPF) in accordance with embodiments of the application, wherein FIG. 3A shows a top down optical microscopy view of a single BMG gripper before mold removal, FIG. 3B shows an optical microscopy image of the demolded BMG gripping array, FIG. 3C provides a scanning electron microscopy (SEM) image of the same gripping array, showcasing individual grippers, and FIG. 3D shows a SEM image of single gripper's anchoring tip at even higher magnification.

FIG. 4 provides data from mechanical testing of individual BMG grippers of the gripping arrays, and a picture showing a gripper's failure under compression (inset), in accordance with embodiments of the application.

FIG. 5 illustrates various gripper anchoring tip geometries (from left to right: star, chicken feet (3-pronged), hoe, and single spine), and gripper packing densities accessible via thermoplastic forming of BMGs during the fabrication of gripping arrays in accordance with embodiments of the application.

FIG. 6 illustrates a precision mold, which is approximately 2 inches long, with microscale beam features produced via electrical discharge machining (EDM) methods according to prior art.

FIGS. 7A and 7B illustrate fabrication of BMG gripping arrays with nanoscale gripping features using commercial off-the-shelf (COTS) anodized aluminum oxide (AAO) and black Si templates, in accordance with embodiments of the application.

FIG. 8 provides data that compares the coefficient of friction (the resistance to slip) under different loads for BMG gripping arrays with different anchoring tip geometries (from left to right, respectively: chicken feet, circle, spider, star) contacting surfaces comprising different materials (from top to bottom, respectively: acrylic, carbon fiber, aluminum, wood), wherein higher coefficient of friction values correspond to higher “gripping strength” of the gripping arrays; and the same data collected for SiC paper of different grit sizes (i.e. 80, 240, 1200) is also provided (on the right) for reference, in accordance with embodiments of the application.

### DETAILED DISCLOSURE

The embodiments of the invention described herein are not intended to be exhaustive or to limit the invention to precise forms disclosed. Rather, the embodiments selected for description have been chosen to enable one skilled in the art to practice the invention.

Turning now to the schemes, images, and data, bulk metallic glass (BMG)-based gripping arrays with nano- or micro-scale gripping features are described, as well as methods of fabrication and use thereof. In many embodiments, the BMG-based gripping arrays are fabricated with high fidelity at the nano- or micro-scale via thermoplastic forming methods typically used with polymeric materials, yet these gripping arrays possess many of the properties of metallic materials, including excellent mechanical properties, and resistance to wear under adverse conditions. In many embodiments, the performance of the gripping arrays of the instant application is independent of the material composition of the surface they contact and grip. In many embodiments, the gripping arrays are incorporated into a variety of perching/gripping mechanisms and or robotics for applications in a variety of terrains and conditions, including outer space exploration.

Many current approaches to gripping systems and methods rely on nature-inspired microspines or emulate other natural systems, such as, for example, gecko feet setae. Such systems typically comprise arrays of nano- or micro-scale grippers/spines of various designs fabricated from polymeric materials amenable to efficient and reliable fabrication methods, such as, for example, thermoplastic forming (TPF). However, certain applications, such as, for example, space exploration missions, require that all platform components are made of very robust materials that can withstand and operate in adverse conditions, such as extreme temperatures, radiation, and vacuum, with which organic thermoplastic materials are not compatible. In contrast, gripper systems made of metallic materials are expected to have much enhanced robustness and resistance to wear in general, but the nano- or micro-scale structures necessary for effective gripping action are difficult to manufacture from conventional metallic alloys.

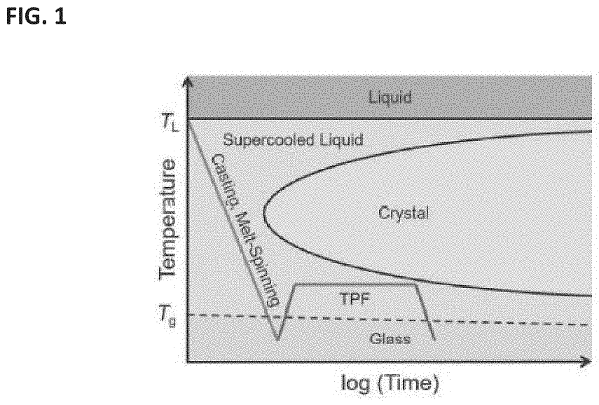

Amorphous metals, also known as metallic glasses or glassy metals, are solid, metal-based alloy materials with a disordered and, therefore, glass-like atomic structure, in contrast to the highly ordered atomic structure of conventional crystalline metal materials. Amorphous metal alloys are typically very complex, precisely balanced compositions of elements comprising one main (i.e., predominant in amount) metal element (M), and one or more other metal or non-metal elements, formulated to allow for the melts of these materials to be quenched into a vitreous state and avoid crystallization upon cooling. The metallic glass alloys that can be cast (with reasonable cooling rates) into a relatively large thickness (generally over 1 mm) without pronounced crystallization are called bulk metallic glasses (BMGs). More specifically, as depicted in FIG. 1, BMGs possess extensive supercooled liquid regions with sufficient thermal stability to be processed via thermoplastic forming methods, wherein the lack of a crystalline structure allows accurate molding of BMG features, including at the micro- and nano-scale.

This application is directed to embodiments of gripping arrays comprising nano- or micro-scale structures, wherein the nano- or micro-scale structures comprise robust, metal-based alloy materials, and methods of manufacture and use thereof. In particular, the embodiments are directed to gripping arrays comprising bulk metallic glass alloys. In many embodiments, the gripping arrays are fabricated from BMGs via thermoplastic forming methods. In many embodiments, the gripping arrays are hierarchical conforming gripping arrays. In many such embodiments, each array comprises a plurality of nano- or micro-scale grippers, wherein each nano- or micro-scale gripper, in turn, at least comprises a stalk, and an anchoring tip of a given geometry attached to the available end of the stalk. In some embodiments, the stalk cross-section is circular, which gives such stalks no preferred bending direction, however, in other embodiments, the stalk cross-section has another, non-circular, cross-section geometry. In many embodiments, the stalks are 1 micron to up to 1 millimeter thick, and from 1 micron to up to 1 centimeter long. In some embodiments, the stalk is 50 microns thick and 500 micron long. In general, in many embodiments, the stalk width determines how much each gripper can flex and, therefore, ultimately determines the gripping force of the gripping arrays. In many embodiments, the geometry of the anchoring tip is selected from the list consisting of: V, chicken feet, such as three-pronged chicken feet, star, circle, spider, hoe, single spine, another complex multi-pronged shape, and any combination thereof. In many embodiments, the anchoring tip is sharp for enhanced gripping ability, wherein manufacturing with BMGs according to methods of embodiments allows for fabrication of very sharp anchoring tips.

In many embodiments, the individual grippers may comprise elements of multiple length scales, for example—a small anchoring tip atop a long flexible stalk, that together serve a new function. In many embodiments, the length scale mismatch between the length of the stalk and the dimensions of the anchoring tip are on the order of 10 to 1, e.g. a 100 micron long stalk may be capped by a 10 micron or smaller gripper. However, in many embodiments the scale mismatch between the gripper elements is even larger. In many embodiments, the length scale mismatch ensures long wabbly/buckling stalks that conform to a contact surface and load share. In many embodiments, the length scale of the anchoring tip is matched to the length scale of the roughness of the surface the gripping array is to contact. In many embodiments, the length scale of the stalks and the overall length scale of the gripping array of embodiments are matched to the intended application, wherein it is ensured that the gripping array optimally conforms to its contact surface.

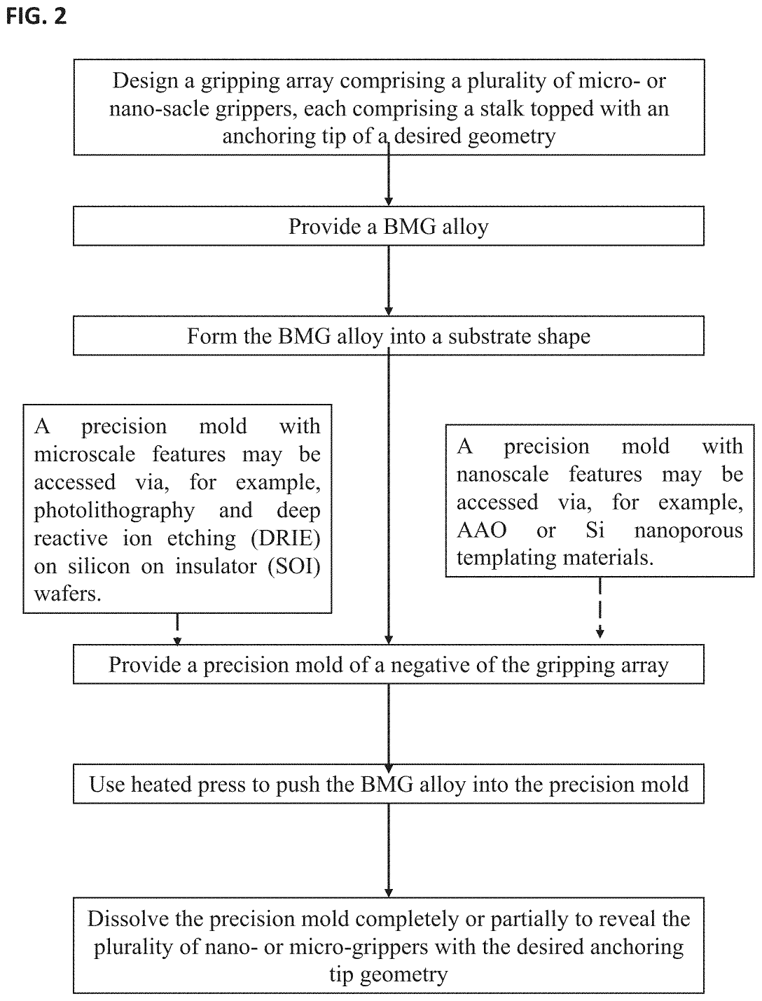

In many embodiments, the gripping arrays of the nano- or micro-scale grippers are fabricated from BMG alloys via thermoplastic forming methods as outlined in, for example, the scheme in FIG. 2. To this end, in some embodiments, a bulk metallic glass alloy of choice is first provided and optionally pre-formed into a desired overall substrate shape. In many embodiments, the BMG alloy selection is guided by compatibility with TPF methods. For example, in some embodiments, the selected BMG alloy compositions achieve a low enough viscosity when heated above the glass transition temperature to maximally fill a mold of any complexity and scale without perceptible crystallization during the gripping array fabrication process. In many embodiments, the BMG alloy is any alloy from ZrTiCuBe family. In many embodiments, the bulk metallic glass alloy is selected from the group consisting of: Zr₃₅Ti₃₀Cu_{8.25}Be_{26.75}, Zr₄₄Ti₁₁Cu₁₀Ni₁₀Be₂₅, Zr_{41.2}Ti_{13.8}Ni_{12.5}Cu₁₀Be_{22.5}, Pd₄₃Cu₂₇Ni₁₀P₂₀, Pt_{57.5}Cu_{14.7}Ni_{5.3}P_{22.5}, Au₄₉Ag_{5.5}Pd_{2.3}Cu_{26.9}Si_{16.3}, Mg₆₅Cu₂₅Y₁₀.

In some embodiments, a precision mold is next provided, wherein the precision mold is a negative of a gripping array of embodiments. In many embodiments, the precision mold comprises silicon etched to the desired pattern and resolution. More specifically, in many embodiments, the precision mold with microscale features is made using photolithography and deep reactive ion etching (DRIE) on silicon on insulator (SOI) wafers. In some embodiments, another robust mold making process is used that allows for nano- or micro-scale resolution of mold features. For example, in some embodiments, molds comprising nanoporous anodized aluminum oxide, silicon, or black silicon materials are used to fabricate gripping arrays with nanoscale grippers. In some embodiments, molds comprise ceramics. In many embodiments, the mold of choice comprises a material that allows for forming of complex micro- and or nano-scale 3D negative features, including features with sharp ends and or edges, wherein the mold material can be easily dissolved, or similarly removed, from the completed gripping array without pulling (i.e., the mold is consumable), as the gripping feature designs of embodiments, e.g., hooks, do not allow for “pull off”/reusable types of molds. Accordingly, in some embodiments, the precision mold is, for example, dissolvable by immersion into an etching solution, such as, for example, a solution of KOH. In other embodiments, the precision mold can be removed by mechanical breaking without any damage to the gripping array inside the precision mold, such as for example, via application of ultrasound, or, as another example, via flexing the mold material. In such embodiments, wherein the brittle precision mold is removed mechanically by chipping away, it is especially beneficial to have the BMG gripping arrays of embodiments, because, in general, BMG materials have high elasticity, typically higher than a breakable mold's material, and, therefore, the mechanical removal of the mold will not break or otherwise damage the gripping array being molded.

In many embodiments, a heated press is next used to push the BMG alloy into the precision mold. In many embodiments, the heating of the BMG alloy is controlled so as not to cause unwanted crystallization. However, in some embodiments, it may be desirable to allow the BMG alloy to crystallize, partially or fully, during or after forming to obtain gripping arrays with advantageous material properties. For example, in some embodiments, the BMG alloy may be allowed to partially crystallize into an amorphous matrix composite material to obtain gripping arrays with, for example, enhanced mechanical properties. As another example, in some other embodiments, the BMG may be allowed to fully crystallize to obtain gripping arrays with the properties characteristic of the crystalline phase, such as, for example, enhanced hardness and or thermal stability. As yet another example, in some embodiments, the crystalline structure of the gripping array material is inconsequential to the intended application in view of the overall gripping array design, and, therefore, any heating that promotes forming may be applied. In many embodiments, once the BMG alloy forming is completed, and, in some embodiments, the mold and alloy are cooled, the precision mold is partially or fully dissolved away, or otherwise removed, to reveal a gripping array of nano- or micro-scale grippers comprising BMG.

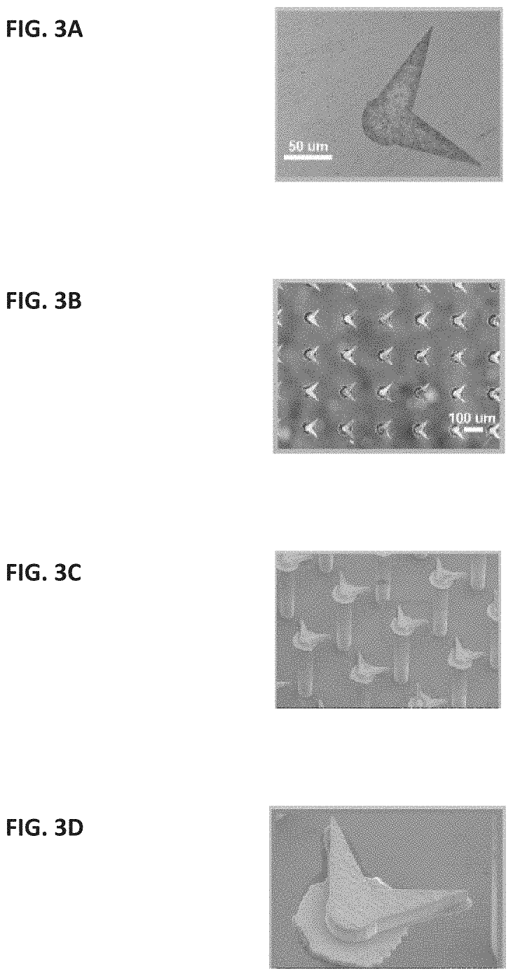

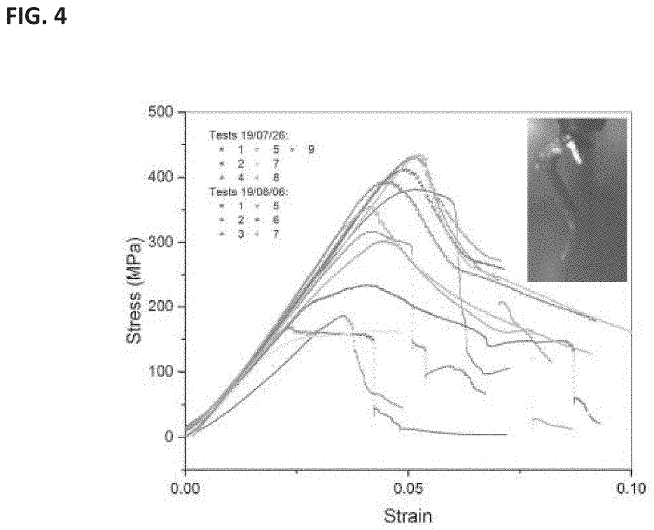

Accordingly, in many embodiments, TPF of BMGs yields high-fidelity arrays of nano- or micro-scale structures with tips designed to anchor onto surfaces and comprising robust materials with many advantageous properties of conventional metallic alloys. FIGS. 3A through 3D provide an illustrative example of a gripping array fabricated from a BMG alloy according to many embodiments. More specifically, FIG. 3A shows a top down view of a single gripper's anchoring tip (still embedded in the mold), wherein the anchoring tip features an exemplary “V” geometry according to many embodiments, while FIG. 3B shows a top down optical microscopy view of a de-molded portion of a highly ordered array of a plurality of microscale grippers with the same anchoring tip. In addition, FIG. 3C provides a scanning electron microscopy (SEM) image of the ordered array of the same grippers, showing the stalk and the anchoring tip, and FIG. 3D shows the well-defined tip at even higher magnification. Together, these images illustrate that the well-defined and highly ordered hierarchical gripping arrays of embodiments can be manufactured from BMGs via TPF methods with excellent precision. In many embodiments, TPF of BMGs allows the fabrication of arrays of grippers that are, for example, 50 microns thick and 500 micron long. In many embodiments, the grippers in an array are 1 micron to 1 millimeter thick and 1 micron to 1 centimeter long. In many such embodiments, a single BMG gripper structure with these dimensions can withstand an average maximum stress of 411 MPa, at which point the stalk fails by buckling under compression, as illustrated with mechanical testing data and the picture provided in FIG. 4. In many embodiments, the specific value of the average maximum stress depends on the BMG alloy and dimensions of the stalk and can be adjusted for the desired application.

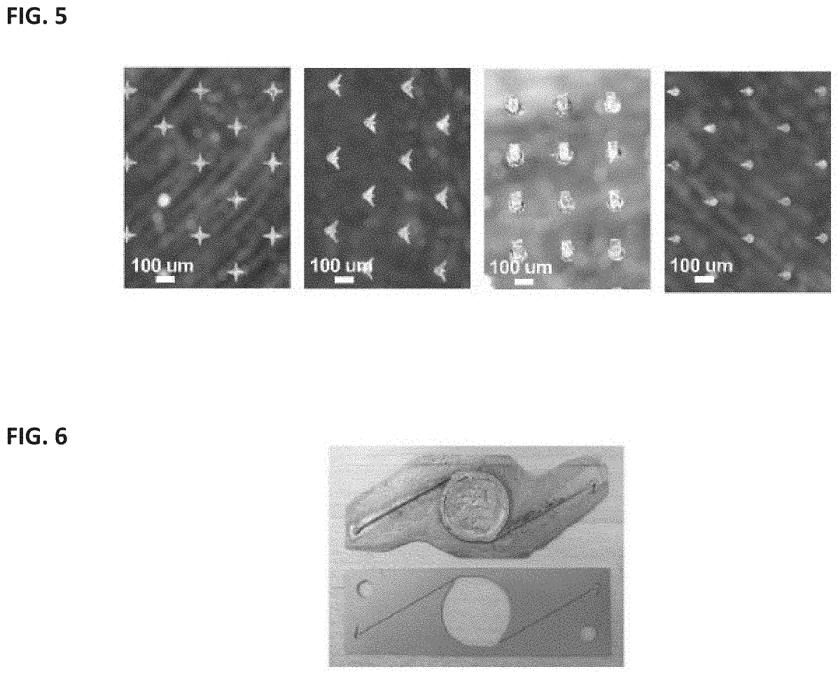

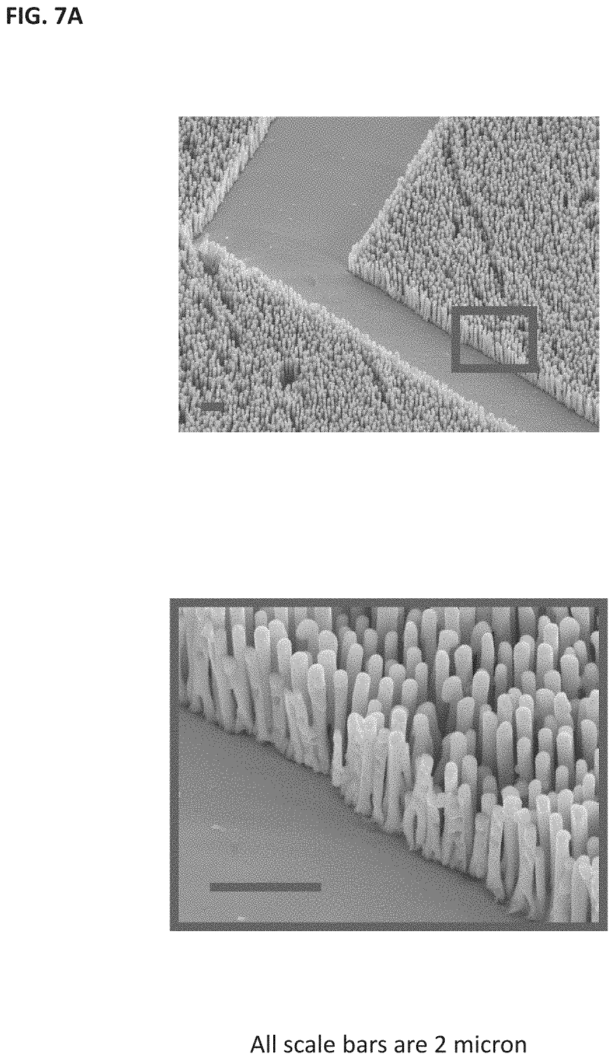

Furthermore, the methods of the instant disclosure allow for fabrication of grippers with a variety of anchoring tip geometries and different packing densities of grippers within the gripping arrays of embodiments. More specifically, as illustrated in FIG. 5, the versatility of silicon micromachining technology employed in the precision mold manufacturing methods of many embodiments allows for the production of a variety of gripping arrays differing in anchoring tip geometry and gripper structure packing densities. The ability to control the packing density of the flexible BMG grippers within the gripping arrays of embodiments is an important advantage of the instantly disclosed methods, because the distance between individual grippers affects how far each stalk can flex/buckle, i.e., for example, more dense arrays constrain stalk flexing, which, in turn, affects the anchoring force and gripping mechanism of the gripping arrays of embodiments. Accordingly, in many embodiments, precision molds are used to control the distance between the stalks and precisely tailor the overall stalk arrangement/pattern within the gripping arrays of embodiments to adjust gripping strength as needed. For example, the first, second, and forth images in FIG. 5 illustrate a gripper packing pattern different from that of the third image in FIG. 5, wherein the first group has a “hexagonal” packing configuration and the remaining image has a “cubic” packing configuration. In addition, in some embodiments, thin (10 to 1000 microns) stalk features can be added to the grippers with the help of precision molds fabricated from metals using electrical discharge machining (EDM), as illustrated by FIG. 6.

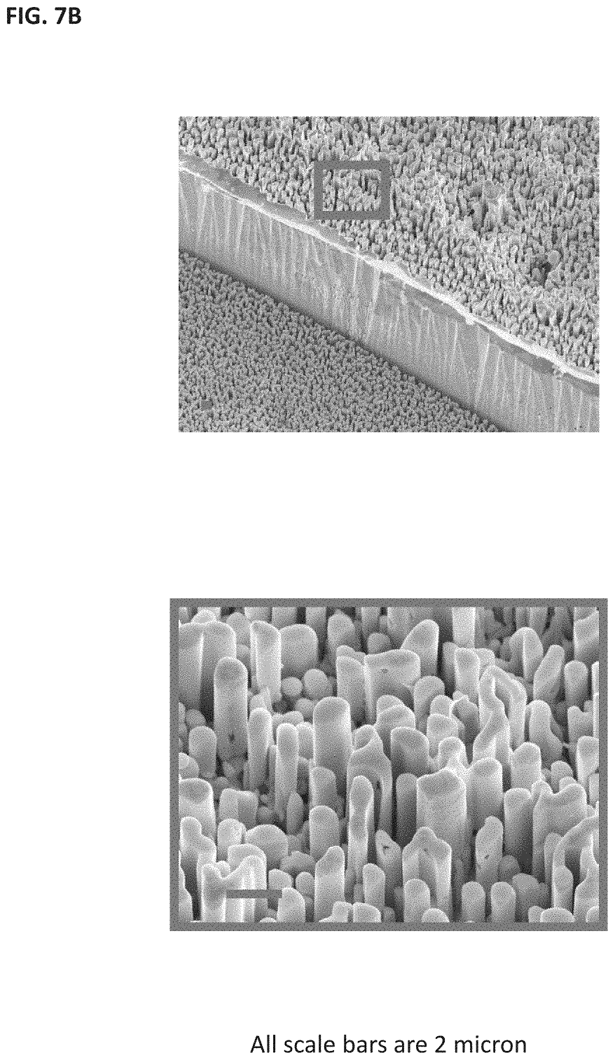

In addition, the methods of embodiments allow for the fabrication of gripping arrays with nanoscale gripping structures and elements. In some embodiments, arrays of nanoscale, BMG gripping structures are fabricated via molding with commercial off-the-shelf nanoporous anodized aluminum oxide (AAO) templates or designer Si or black Si templates. For example, FIGS. 7A and 7B provide SEM images of such gripping arrays comprising nanoscale BMG grippers fabricated with nanoporous molds comprising AAO (FIG. 7A) and black Si (FIG. 7B). In general, using BMG alloys for fabrication of the gripping arrays of embodiments according to methods of many embodiments allows accurate reproduction of gripping structures and features at both the nano- and micro-scale. Furthermore, in some embodiments, gripping arrays of gripping structures are fabricated, wherein each gripping structure comprises a microscale stalk and a nanoscale anchoring tip. Accordingly, the methods of embodiments allow, for the first time, facile, reliable, and scalable manufacturing of gripping arrays with very robust nano- and or micro-scale, complex gripping structures, including gripping structures with multiple length scales, having many metallic-like physical properties. One example of advantageous properties afforded by BMGs is that these materials are superelastic and, in contrast to conventional metallic materials, do not work harden after repeated use, that is, they can withstand repeated bending and buckling.

Although not to be bound by theory, it is believed that the gripping mechanism of the gripping arrays of embodiments rely on the ability of the long and flexible (yet strong) stalk portion of the gripper structure to bend and buckle, allowing the overall gripping array to conform to a contact surface and to load share on the contact surface's rough spots. As such, the gripping arrays of embodiments allow for a strong coupling to the contact surface and resist slip. Accordingly, in many embodiments, it is desired to maximize the gripping arrays' resistance to slip under load, wherein arrays of gripping structures allow opportunistic perching on surface roughness and the stalk buckling shares load over many contact points. More specifically, in many embodiments, surface dependent gripping is driven by the available positive features on the contact surface and the strength of the contact surface, wherein a buckling gripping array of embodiments is scaled to have an anchoring tip size, a gripper height, and density, and an overall gripping array area commensurate with the scale of the contact surface's positive (i.e., protruding) features, to ensure sufficient conformity of the gripping array to the contact surface and gripping action. Accordingly, in many embodiments, the stalks are scaled to buckle under an appropriate normal force allowing the anchoring tips to share the load over the gripping area, and, thus, to provide a safe reliable gripping method for a wide variety of materials and surface properties. For example, the gripping arrays can be designed according to many embodiments to safely (without penetrating the surface) attach to textiles of any coarseness or weave, including fabrics as soft as silk, or even skin. On the other hand, in other embodiments, the gripping arrays can also be design to strongly grip to inorganic surfaces, such as, for example, rock/terrain, or metallic alloy, including another or the same BMG alloy. In many embodiments, the gripping force of the BMG gripping arrays increases linearly with the number and height/scale of positive features on the contact surface. In many embodiments, the gripping arrays are robust to dust and liquid. Furthermore, in many embodiments, the gripping arrays demonstrate resistance to slip that is independent of the contact surface material composition.

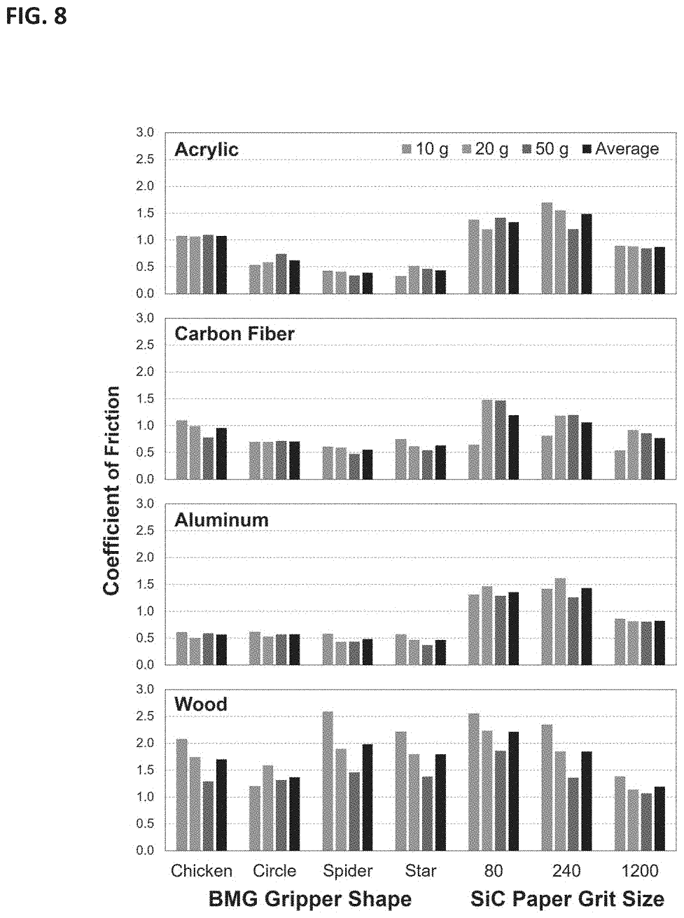

FIG. 8 presents data collected to provide a figure of merit for the performance of the gripping arrays of embodiments. More specifically, the data in FIG. 8 shows the relationships between the gripping arrays' resistance to slip (represented by coefficient of friction) under a given load (proof weights of 10 g, which is considered a light load, and 20 g and 50 g, which are considered a medium load), the geometry of their anchoring tip (i.e., chicken feet, circle, spider, star), and the material composition of the contact surface (i.e. acrylic, carbon fiber, aluminum, and wood), wherein the higher coefficient of friction indicates stronger gripping performance. In addition, FIG. 8 provides the same data for SiC paper of different grit sizes (i.e. 80, 240, 1200) as a reference. The contact surfaces were all machined flat and smooth prior the testing. The data shows, that the softer materials, such as acrylic and carbon fiber, allow for the stronger impingement of the grippers than harder aluminum. Furthermore, the gripping arrays of embodiments work better on textured surfaces, such as wood, wherein the anchoring tips of the grippers length scale match with the surface features of the wooden contact surface, which are on the order of 80 to 100 microns. Notably, in additional experiments not shown in FIG. 9, wherein the BMG gripping arrays of embodiments were tested with unmachined (i.e., rough) aluminum surface, the gripping was very strong, much stronger than with the equivalent smooth aluminum surfaces. According to this data, wherein the coefficient of friction appears to decrease with increased normal load, and wherein, also, the geometry of the anchoring tip appears to be more important than the material composition of the contact surface, the gripper's resistance to slip is more closely dependent on the gripper's anchoring tip geometry and the gripper's stalk width, than on the contact surface composition. Therefore, in many embodiments, the optimization of the BMG gripping arrays relies on the optimization of the geometry of the grippers' anchoring tips, coupled with the proper stalk width and length (i.e., gripper scaling).

In some embodiments, the BMG-based gripping arrays are used by themselves as general use adhesives, while in other embodiments the gripping arrays are incorporated into robotic mechanisms to endow such mechanisms with perching and or gripping capabilities. In many embodiments, the gripping arrays of the instant application provide robust perching and or gripping solutions for a wide range of terrains and conditions, including, but not limited to, those encountered during outer space exploration. In many embodiments, the gripping arrays of the instant application are either independent of the contact surface composition or can be easily adjusted for compatibility. As such, examples of applications suitable for the BMG gripping arrays according to many embodiments, include, but are not limited to: metal (therefore, fire safe) Velcro for various surfaces, including, for example, for attaching buttons or jewelry onto items of clothing without destroying the fabric; mechanical adhesive for bonding surfaces that otherwise require metallurgically bonding, welding, or use of other, less advantageous, adhesives; robotic gripping of both soft and fragile, as well as rough and tough surfaces and or terrain. In many embodiments the BMG gripping arrays are used in designer interlocking systems, wherein two or more gripping arrays comprising the same or different materials, wherein at least one gripping array comprises a BMG, are designed to have grippers with complimentary features for very strong interlocking and hold.

### DOCTRINE OF EQUIVALENTS

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

1. A gripping array comprising:
a substrate, characterized by a substrate thickness and a substrate area; and
a plurality of grippers covering the substrate, each gripper comprising a stalk, characterized by a stalk length and a stalk width, and an anchoring tip at the available end of the stalk, characterized by an anchoring tip geometry and at least one anchoring tip dimension, wherein
the plurality of grippers comprises a bulk metallic glass, and wherein
the gripping array is characterized by a gripper density, a gripper pattern, and an ability to adhere to a surface having surface features upon a contact between the surface and the plurality of grippers.

2. The gripping array of claim 1, wherein the bulk metallic glass is selected from the group consisting of: Zr₃₅Ti₃₀Cu_{8.25}Be_{26.75}, Zr₄₄Ti₁₁Cu₁₀Ni₁₀Be₂₅, Zr_{41.2}Ti_{113.8}Ni_{12.5}Cu₁₀Be_{22.5}, Pd₄₃Cu₂₇Ni₁₀P₂₀, Pt_{57.5}Cu_{14.7}Ni_{5.3}P_{22.5}, Au₄₉Ag_{5.5}Pd_{2.3}Cu_{26.9}Si_{16.3}, Mg₆₅Cu₂₅Y₁₀.

3. The gripping array of claim 1, wherein the plurality of grippers is characterized by microscale dimensions.

4. The gripping array of claim 1, wherein the plurality of grippers is characterized by nanoscale dimensions.

5. The gripping array of claim 1, wherein the stalk length is microscale and the at least one anchoring tip dimension is nanoscale.

6. The gripping array of claim 1, wherein the stalk length is at least 10 times larger than the at least one anchoring tip dimension.

7. The gripping array of claim 1, wherein the stalk length is at least 10 times larger than the stalk width.

8. The gripping array of claim 1, wherein the stalk width is 1 micron to 1 millimeter.

9. The gripping array of claim 8, wherein the stalk width is 50 nm.

10. The gripping array of claim 1, wherein the stalk length is 1 micron to 1 centimeter.

11. The gripping array of claim 10, wherein the stalk length is 500 nm.

12. The gripping array of claim 1, wherein the anchoring tip geometry is selected from the group consisting of: V, chicken feet, such as three-pronged chicken feet, star, circle, spider, hoe, single spine, another complex multi-pronged shape, and any combination thereof.

13. The gripping array of claim 1, wherein the gripper pattern is selected from the group consisting of: hexagonal packing, cubic packing, and any combination thereof.

14. The gripping array of claim 1, wherein at least one feature selected from the list consisting of: the stalk length, the stalk width, the at least one anchoring tip dimension, the gripper density, and the gripper pattern, are scaled with the surface features to optimally grip the surface.

15. The gripping array of claim 1, wherein the substrate thickness and the substrate area are optimized to conform to the surface.

16. A method of fabricating a gripping array comprising:
providing a bulk metallic glass alloy;
providing a precision mold, wherein the precision mold is a negative of the gripping array;
using a heated press to push the bulk metallic glass alloy into the precision mold and cooling the precision mold to from the gripping array comprising a bulk metallic glass; and
partially or fully removing the precision mold to reveal the gripping array comprising:
a substrate, characterized by a substrate thickness and a substrate area; and
a plurality of grippers covering the substrate, each gripper comprising a stalk, characterized by a stalk length and a stalk width, and an anchoring tip at the available end of the stalk, characterized by an anchoring tip geometry and at least one anchoring tip dimension, wherein
the plurality of grippers comprises the bulk metallic glass, and wherein
the gripping array is characterized by a gripper density, a gripper pattern, and an ability to adhere to a surface having surface features upon a contact between the surface and the plurality of grippers.

17. The method of claim 16, wherein the bulk metallic glass alloy is selected from the group consisting of: Zr₃₅Ti₃₀Cu_{8.25}Be_{26.75}, Zr₄₄Ti₁₁Cu₁₀Ni₁₀Be₂₅, Zr_{41.2}Ti_{13.8}Ni_{12.5}Cu₁₀Be_{22.5}, Pd₄₃Cu₂₇Ni₁₀P₂₀, Pt_{57.5}Cu_{14.7}Ni_{5.3}P_{22.5}, Au₄₉Ag_{5.5}Pd_{2.3}Cu_{26.9}Si_{16.3}, Mg₆₅Cu₂₅Y₁₀.

18. The method of claim 16, wherein the precision mold comprises microscale features.

19. The method of claim 18, wherein the precision mold comprises microetched silicon.

20. The method of claim 18, wherein the precision mold is fabricated using photolithography and deep reactive ion etching on silicon on insulator wafers.

21. The method of claim 16, wherein the precision mold comprises nanoscale features.

22. The method of claim 21, wherein the precision mold comprises a nanoporous material selected from the group consisting of: anodized aluminum oxide, Si, black Si, ceramic.

23. A mobility platform comprising at least one gripping array comprising:
a substrate, characterized by a substrate thickness and a substrate area; and
a plurality of grippers covering the substrate, each gripper comprising a stalk, characterized by a stalk length and a stalk width, and an anchoring tip at the available end of the stalk, characterized by an anchoring tip geometry and at least one anchoring tip dimension, wherein
the plurality of grippers comprises a bulk metallic glass, and wherein
the gripping array is characterized by a gripper density, a gripper pattern, and an ability to adhere to a surface having surface features upon a contact between the surface and the plurality of grippers.
